(19) United States
(12) Patent Application Publication
(10) Pub. No.: US 2012/0294253 A1
(43) Pub. Date: Nov. 22, 2012

(54) METHOD AND APPARATUS FOR TRANSMITTING AND RECEIVING REFERENCE SIGNAL IN WIRELESS COMMUNICATION SYSTEM

(75) Inventors: Sungjun Yoon, Seoul (KR); Kitae Kim, Suwon-si (KR); Kyoungmin Park, Goyang-si (KR)

(73) Assignee: PANTECH CO., LTD., Seoul (KR)

(21) Appl. No.: 13/521,433

(22) PCT Filed: Jan. 7, 2011
(86) PCT No.: PCT/KR2011/000113

§ 371 Date: Jul. 10, 2012

(30) Foreign Application Priority Data
Jan. 12, 2010 (KR) 10-2010-0002572

(51) Int. Cl. H04W 72/04

(52) U.S. Cl. 370/329

(57) ABSTRACT

A method for composing, transmitting, and receiving a reference signal in a wireless communication system for performing non-continuous resource allocation on the basis of a plurality of resource clusters is provided. An increase in a Cubic Metric (CM) and a Peak to Average Power Ratio (PAPR) generated in a process for composing, transmitting, and receiving a same reference signal according to each resource cluster by composing, transmitting, and receiving the reference signal distinguishable from each resource cluster in the wireless communication system for performing the non-continuous resource allocation on the basis of the resource clusters may be prevented.

### CROSS-REFERENCE TO RELATED APPLICATIONS

This application is the National Stage Entry of International Application No. PCT/KR2011/000113, filed on Jan. 7, 2011 and claims priority from and the benefit of Korean Patent Application No. 10-2010-0002572, filed on Jan. 12, 2010, all of which are hereby incorporated by reference for all purposes as if fully set forth herein.

### BACKGROUND

1. Field

The present disclosure relates to a wireless communication system, and particularly, to a method and apparatus for generating and transceiving a reference signal in a wireless communication system that performs non-contiguous resource allocation based on a is plurality of resource clusters.

2. Discussion of the Background

In an orthogonal frequency division multiplexing (OFDM)-based wireless communication system, one of the main reasons of deterioration of performance of the system is an increase in a cubic metric (CM) and a peak to average power ratio (PAPR).

To overcome the drawback, a next generation wireless communication system, such as long term evolution (LTE) and the like, may use an orthogonal frequency division multiple access (OFDMA) as a modulation/demodulation scheme in a downlink (DL), and may use a discrete Fourier transform (DFT)-spread (S)-OFDMA in an uplink (UL) where the drawback associated with the CM/PAPR is worse, so as to reduce CM/PARP.

The DFT-S-OFDMA may also be referred to as a single carrier-frequency division multiple access (SC-FDMA).

In addition, in a case of the DFT-S-OFDMA, LTE-advanced (LTE-A) that is developed from LTE may support non-contiguous resource allocation based on a plurality of resource clusters, whereas LTE supports contiguous resource allocation.

However, when the same reference signal is generated for a plurality of resource clusters, and is transmitted and received in a single component carrier (CC), that is, an intra-CC, CM/PAPR increases when compared to the existing LTE system that uses a single cluster.

Therefore, there is a desire for a method of generating and transceiving a reference signal, so as to overcome the drawback.

### SUMMARY

Therefore, the present invention has been made in view of the above-mentioned problems, and an aspect of the present invention is to provide a method and apparatus for generating and transceiving a reference signal in a wireless communication system that performs non-contiguous resource allocation based on a plurality of resource clusters.

Another aspect of the present invention is to provide a method and apparatus for forming and transceiving a reference signal that is distinguished for each cluster in an intra CC.

Another aspect of the present invention is to provide a method and apparatus in which a user equipment (UE) forms and transmits a reference signal distinguished for each resource cluster in an intra CC, and a e-NodeB (eNB) receives the reference signal.

Another aspect of the present invention is to provide a method and apparatus for transceiving a reference signal that reduces deterioration of performance of a system in a wireless communication system that performs non-contiguous resource allocation based on a plurality of resource clusters.

Another aspect of the present invention is to provide a reference signal that reduces a cubic metric (CM) and a peak to average power ratio (PAPR) in a wireless communication system that performs non-contiguous resource allocation based on a plurality of resource clusters.

In accordance with an aspect of the present invention, there is provided a method of transmitting a reference signal in a wireless communication system, the method including is identifying at least one cluster corresponding to successive resource blocks from among a plurality of subcarrier sets, generating a reference signal sequence to be distinguished for each identified cluster, and generating a reference signal to be distinguished for each identified cluster, based on the generated reference signal sequence.

Generating of the reference signal sequence using the different phase cyclic shift value α for each identified cluster includes generating the reference signal sequence by applying at least one of:

α=2πn_{cs}/12, and

n_{cs}=(n_{DMRS}⁽¹⁾+n_{DMRS}⁽²⁾+n_{PRS}(nₛ)+n_{cluster})mod 12; 1)

α=2πn_{cs}/12, and

n_{cs}=(n_{DMRS}⁽¹⁾+n_{DMRS}⁽²⁾+n_{PRS}(nₛ)+N_{offset}^{cluster})mod 12; 2)

α=2π·(n_{cluster}+1)·n_{cs}/12, and

n_{cs}=(n_{DMRS}⁽¹⁾+n_{DMRS}⁽²⁾+n_{PRS}(nₛ))mod 12; and 3)

α=2π·(N_{offset}^{cluster}+1)·n_{cs}/12, and

n_{cs}=(n_{DMRS}⁽¹⁾+n_{DMRS}⁽²⁾+n_{PRS}(nₛ))mod 12. 4)

In accordance with another aspect of the present invention, there is provided an apparatus for transmitting a reference signal in a wireless communication system, the apparatus including: a cluster group information unit to identify clusters corresponding to successive resource blocks from among a plurality of subcarrier sets, a controller to perform controlling so is as to generate a reference signal sequence to be distinguished for each identified cluster, and a reference signal generator to generate a reference signal to be distinguished for each identified cluster, based on the generated reference signal sequence.

### BRIEF DESCRIPTION OF THE DRAWINGS

FIG. 1 is a diagram illustrating a wireless communication system according to an embodiment of the present invention;

FIG. 2 is a diagram illustrating a wireless communication system and extension of a frequency in a carrier aggregation (CA) environment according to an embodiment of the present invention;

FIG. 3 is a diagram illustrating a wireless communication system that performs non-contiguous resource allocation based on a plurality of resource clusters according to an embodiment of the present invention;

FIG. 4 is a diagram illustrating that an N^{th} reference signal sequence for each resource cluster is repeated in a wireless communication system that uses a plurality of resource clusters according to an embodiment of the present invention;

FIG. 5 is a diagram illustrating that reference signal sequences different for each resource cluster are used in a wireless communication system that uses a plurality of resource clusters according to an embodiment of the present invention;

FIG. 6 is a flowchart illustrating a process of transmitting a reference signal according to an embodiment of the present invention;

FIG. 7 is a diagram illustrating a transmitting apparatus that generates a reference signal according to an embodiment of the present invention;

FIG. 8 is a flowchart illustrating a method of receiving a reference signal according to an embodiment of the present invention; and

FIG. 9 is a diagram illustrating a configuration of a reference signal receiving apparatus according to an embodiment of the present invention.

### DETAILED DESCRIPTION OF THE ILLUSTRATED EMBODIMENTS

Hereinafter, exemplary embodiments of the present invention will be described with reference to the accompanying drawings. In the following description, the same elements will be designated by the same reference numerals although they are shown in different drawings. Further, in the following description of the present invention, a detailed description of known functions and configurations incorporated herein will be omitted when it may make the subject matter of the present invention rather unclear.

In addition, terms, such as first, second, A, B, (a), (b) or the like may be used herein when describing components of the present invention. Each of these terminologies is not used to define an essence, order or sequence of a corresponding component but used merely to is distinguish the corresponding component from other component(s). It should be noted that if it is described in the specification that one component is “connected,” “coupled” or “joined” to another component, a third component may be “connected,” “coupled,” and “joined” between the first and second components, although the first component may be directly connected, coupled or joined to the second component.

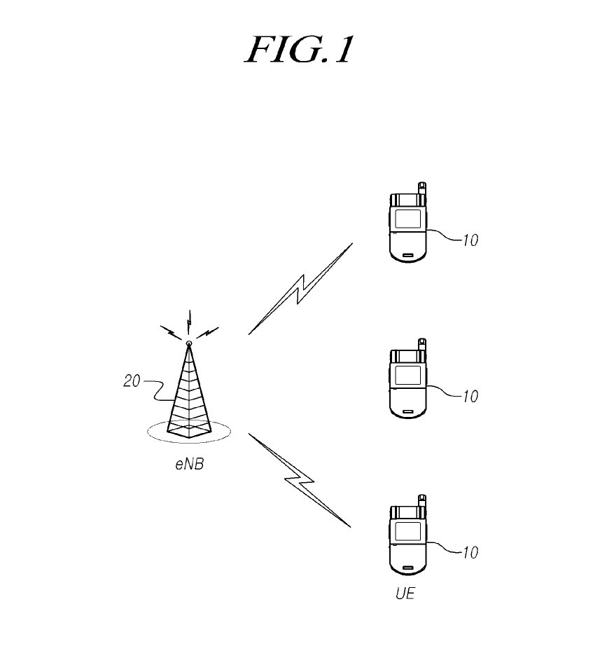

FIG. 1 illustrates a wireless communication system according to an embodiment of the present invention.

The wireless communication system may be widely installed so as to provide various communication services, such as a voice service, packet data, and the like.

Referring to FIG. 1, the wireless communication system may include a user equipment (UE) 10 and an evolved-Node B (eNB) 20. The UE 10 and the eNB 20 may use various power allocation schemes to be described in the descriptions.

Throughout the specifications, the UE 10 may be an inclusive concept indicating a user terminal utilized in a wireless communication, including a UE in WCDMA, LTE, HSPA, and the like, and a mobile station (MS), a user terminal (UT), a subscriber station (SS), a wireless device, and the like in GSM.

The eNB 20 or a cell may refer to a fixed station where communication with the UE 10 is performed, and may also be referred to as a Node-B, a base transceiver system (BTS), an access point, and the like.

The eNB 20 or the cell may be construed as an inclusive concept indicating a portion of an area covered by a base station (BS) in CDMA, a Node B in WCDMA, and the like, and the concept may include various coverage areas, such as a megacell, macrocell, a microcell, a picocell, a femtocell, and the like.

In the specifications, the UE 10 and the eNB 20 are used as two inclusive transceiving subjects to embody the technology and technical concepts described in the specifications, and may not be limited to a predetermined term or word.

A multiple access scheme applied to the wireless communication system may not be limited. The wireless communication system may utilize varied multiple access schemes, such as Code Division Multiple Access (CDMA), Time Division Multiple Access (TDMA), Frequency Division Multiple Access (FDMA), Orthogonal Frequency Division Multiple Access (OFDMA), OFDM-FDMA, OFDM-TDMA, OFDM-CDMA, and the like.

Uplink (UL) transmission and downlink (DL) transmission may be performed based on a time division duplex (TDD) scheme that performs transmission based on different times, or based on a frequency division duplex (FDD) scheme that performs transmission based to on different frequencies.

An embodiment of the present invention may be applicable to resource allocation in an asynchronous wireless communication scheme that is advanced through GSM, WCDMA, and HSPA, to be LTE and LTE-advanced, and may be applicable to resource allocation in a synchronous wireless communication scheme that is advanced through CDMA and CDMA-2000, to be UMB. Embodiments of the present invention may not be limited to a specific wireless communication scheme, and may be applicable to all technical fields to which a technical idea of the present invention is applicable.

Current frequency resources are reaching saturation, and varied technologies are partially utilized in a broad frequency band. To secure a broadband bandwidth to satisfy the demand for a higher data transmission rate, scattered bands may be designed to satisfy basic requirements so that the scattered bands operate as independent systems, respectively, and carrier aggregation (CA) that binds a plurality of bands into a single system may be introduced. In this example, a band that independently operates may be defined to be a component carrier (CC).

Accordingly, the next generation wireless communication system may readily design a system that satisfies service requirements of the next generation wireless communication system by securing the broadband bandwidth through use of a plurality of CCs.

Each CC is able to perform independent system operation and thus, the UE 10 may be able to normally provide a wireless communication system through use of only at least one CC, and may simultaneously provide wireless communication service through use of the plurality of CCs.

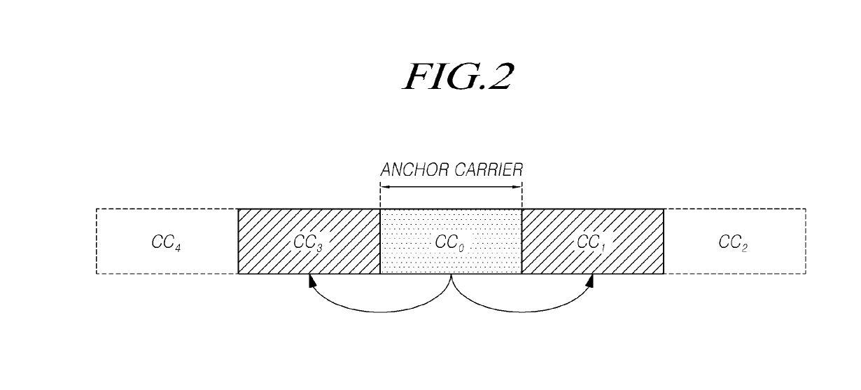

FIG. 2 illustrates a wireless communication system and extension of a frequency in a carrier aggregation (CA) environment according to an embodiment of the present invention.

Referring to FIG. 2, the UE 10 may perform camp-on through all CCs, that is, CC₀ through CC₄. Performing of camp-on may indicate that the UE 10 synchronizes with the eNB 20, and may receive basic control information to be used for communication with the eNB, that is, a master information block (MIB) through a physical broadcast channel (PBCH), a system information block (SIB) through a physical downlink shared channel (PDSCH), and the like, so that communication may be possible in a predetermined frequency band.

In particular, a UL cell bandwidth, a random access parameter, and a UL power control parameter may exist in SIB2. Accordingly, when the UE 10 performs camp-on on the eNB 20, the UE 10 may receive a parameter for using a random access channel (RACH).

Also, basically, the UE 10 may be able to perform random access in all the CCs, that is, CC₀ through CC₄. In particular, the UE 10 is highly likely to perform random access on CC₀ that is used for LTE and has a high probability of being an anchor carrier or a primary carrier (cell) in the current CA environment.

That is, when a plurality of CCs exists in the CA environment, a CC that is regarded as a base CC may be determined to be the anchor carrier. That is, the anchor carrier may be a base to inform about a carrier that operates in a CA mode around the anchor carrier.

Transmission of a reference signal may be required for demodulation of a received signal and/or channel estimation in the wireless communication system. For example, a 3GPP LTE system includes a demodulation reference signal to be used for demodulation of a is physical uplink shared channel (PUSCH) and a physical uplink control channel (PUCCH), and a sounding reference signal that is irrelevant to the PUSCH and the PUCCH.

The same base sequence set may be used for the both reference signals. Hereinafter, both reference signals may be referred to as a UL RS or may be referred to as an RS for ease of descriptions when there is no confusion.

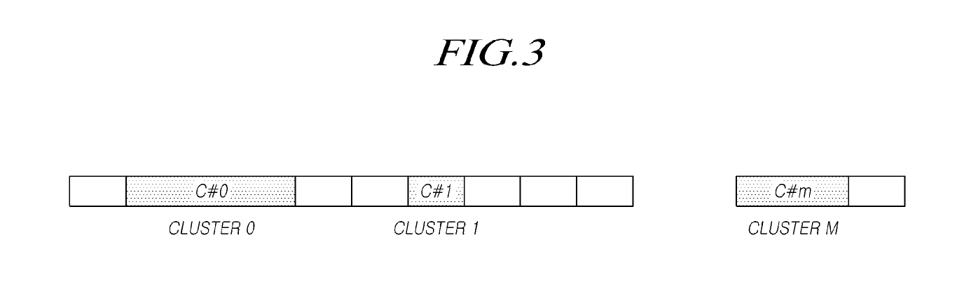

FIG. 3 illustrates a wireless communication system that performs non-contiguous resource allocation based on a plurality of resource clusters according to an embodiment of the present invention.

Referring to FIG. 3, in the wireless communication system that uses a plurality of CCs, non-contiguous resource allocation may be performed with respect to each CC of each cell.

As illustrated in FIG. 3, a single CC in a predetermined cell may be formed of resource blocks (RBs) corresponding to a plurality of subcarrier sets, and a number of RBs may be changed based on a bandwidth of the system.

A bundle of the RBs may be referred to as a resource block group (RBG), and a single bundle of successive RBs or RBGs may be referred to as a resource cluster.

When resource allocation is contiguously performed with respect to the entire bandwidth, like the LTE system according to embodiments of the present invention, the resources may be regarded as a single cluster. In a system such as LTE-A and the like, the is resource cluster corresponding to a bundle of successive RBs or RBGs may be set to be divided into a plurality of portions in the entire bandwidth of a single CC of a predetermined cell, as shown in FIG. 3.

Throughout the specifications, resource allocation based on the divided clusters may be referred to as a clustered non-contiguous resource allocation.

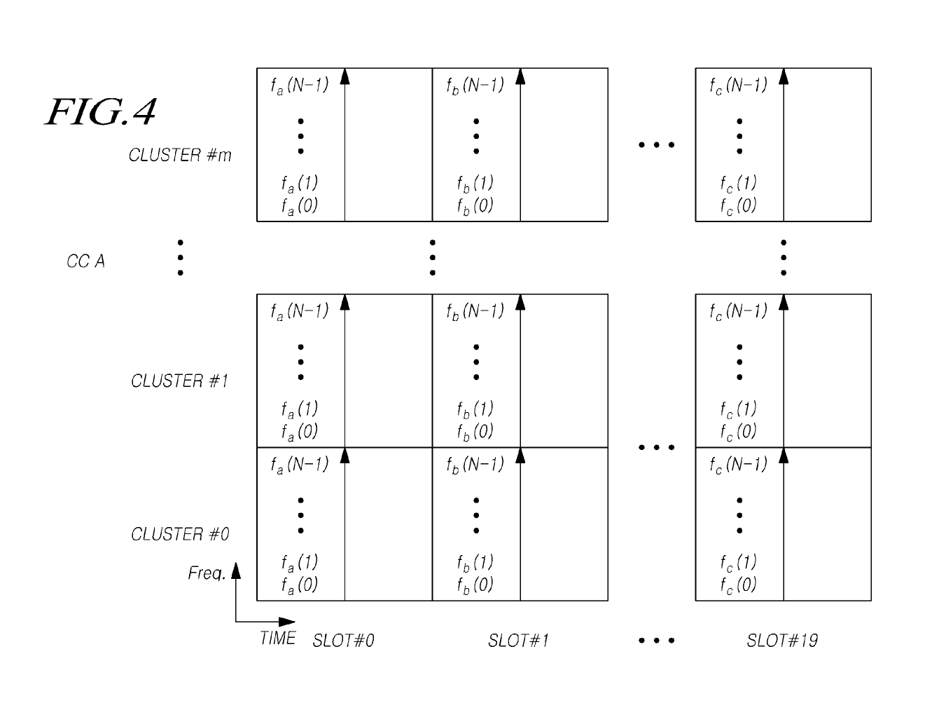

FIG. 4 illustrates that an N^{th} RS sequence for each resource cluster is repeated when a wireless communication system uses a plurality of resource clusters in a single CC of a predetermined cell according to an embodiment of the present invention.

In this example, in a case where an RS is regularly transmitted in a portion of a two-dimensional (2D) communication resource region of time/frequency domains, when the wireless communication system that uses the plurality of resource clusters forms an RS in the same manner as a system that uses a single resource cluster, an RS formed in the total resource cluster may have periodicity, as illustrated in FIG. 4.

In other words, when n RSs having a length of N are used for a single subframe per resource cluster, RSs of the total resource cluster, formed with respect to the single subframe may have a period of N and thus, every N^{th} RS of the resource cluster may be repeatedly used.

For example, RS sequences of an n^{th} slot of M resource clusters of CC A may have the same RS sequence as (fn(0), fn(1) . . . fn(N−1)).

That is, when the wireless communication system that uses the plurality of is resource clusters form an RS in the same manner as the existing method that forms an RS in a single resource cluster, RSs formed with respect to the total resource cluster may have periodicity.

However, the periodicity may increase a cubic metric (CM) and a peak to average power ratio (PAPR) and thus, performance of the wireless communication system may be deteriorated.

Accordingly, the wireless communication system that uses the plurality of resource clusters may form RSs that are distinguished for each resource cluster and may transmit and receive the RSs and thus, may reduce an increase in the CM and the PAPR that may occur when the same RS for each cluster is formed and transmitted and received.

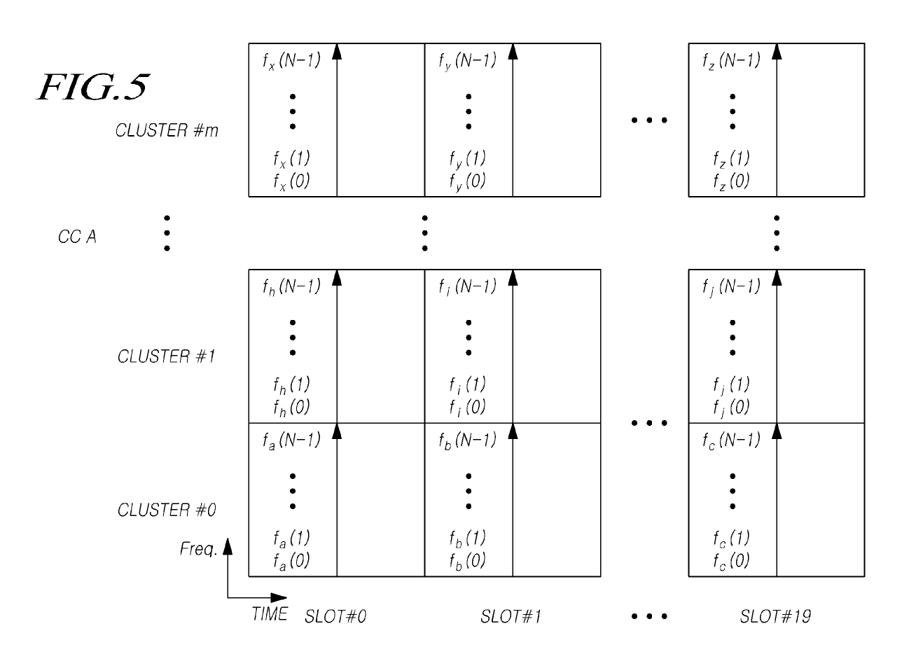

FIG. 5 illustrates that RS sequences different for each resource cluster are used with respect to a CC of a predetermined cell in a wireless communication system that uses a plurality of resource clusters according to an embodiment of the present invention.

Referring to FIG. 5, RSs that are distinguished for each cell, for each CC, and to for each resource cluster may be formed so as to break the periodicity and overcome an increase in a CM and PAPR.

In a case of UL RS, for example a demodulation reference signal (DM-RS) and a sounding reference signal (SRS), a current LTE system may form a base-sequence based on a Zadoff-chu sequence, and may perform phase cyclic shift on the base-sequence so as to form an RS sequence r_{u,v}^{(α)}(n). This may be expressed by Equation 1.

r_{u,v}^{(α)}(n)=e^{jan} r̅_{u,v}(n), 0≦n<M_{sc}^{RS} [Equation 1]

In Equation 1, a total number of subcarriers M_{sc}^{RS} for an RS may be expressed by M_{sc}^{RS}=mN_{sc}^{RB}.

Here, N_{sc}^{RB} denotes a number of subcarriers per RB, and m is an integer having a value in a range from 1 to a maximum number of RBs for a UL. Also, α denotes a phase cyclic shift value. For a DM-RS, α may have 12 values. For an SRS, α may have 8 values.

r̅_{u,v}(n) denotes a base-sequence, which may be expressed by Equation 2.

r̅_{u,v}(n)=x_{q}(n mod N_{ZC}^{RS}), 0≦n<M_{sc}^{RS} for m≧3 in M_{sc}^{RS}=mN_{sc}^{RB}

r̅_{u,v}(n)=e^{jφ(n)n/4}, 0≦n≦M_{sc}^{RS}−1 for m=1 or 2 in M_{sc}^{RS}=mN_{sc}^{RB} [Equation 2]

In Equation 2, q^{th} root Zadoff-chu sequence _{χ}_{_{q}}(m) may be expressed by Equation 3.

$${x}_{q} ( m ) = {e}^{- j \frac{π qm ( m + 1 )}{{N}_{ZC}^{RS}}} , 0 \leq m \leq {N}_{ZC}^{RC} - 1 \qquad [ Equation 3 ]$$

In this example, a length N_{ZC}^{RS} of the Zadoff-chu sequence may be a prime number that is greatest from among numbers less than M_{sc}^{RS}. In this example, a parameter that generates different Zadoff-chu sequences and forms different base-sequences and forms different RSs, may correspond to q, and q may be formed of u and v as shown in Equation 4.

q=└ q̅+½┘+v·(−1)^{└2 q̅┘}

q̅=N_{ZC}^{RS}·(u+1)/31 [Equation 4]

In Equation 4, u corresponding to a sequence-group number may have 30 values, and v corresponding to a base sequence number within a group may have two values, that is, 0 and 1.

In a case of v, a number of cases is only 2 and thus, the number of cases may be insufficient to be used for distinguishing resource clusters.

Accordingly, different base sequences r̅_{u,v}(n) may be formed by using a is difference phase cyclic shift value α, a different root value q of the Zadoff-chu sequence, or a different sequence-group number u for each cluster and thus, RSs different for each resource cluster may be formed.

Here, to distinguish each resource cluster, a cluster number or an offset value for each cluster may need to be added when an RS is formed.

The cluster number may be expressed by, for example, a parameter n_{cluster} and the like, and when a number of resource clusters is M, n_{cluster}ε{0, 1, 2, . . . , M−1}. An offset value for each cluster may be expressed by, for example, a parameter N_{offset}^{cluster} and the like, and when the number of clusters is M, N_{offset}^{cluster}ε{0, 1, 2, . . . , M−1}

In this example, although a total number of resource clusters is M, M or less N_{offset}^{cluster} may be used and a predetermined mapping rule between resource clusters and N_{offset}^{cluster} values may be defined. In this example, for a case of a first resource cluster or a resource cluster having a largest bandwidth, the N_{offset}^{cluster} value may be set to 0, and for other clusters, a value that is different from 0 may be used.

### Embodiment 1

### A Scheme of Changing a Root Value q of a Zadoff-chu Sequence

First, a cluster number or an offset value for each cluster may be added to q of Equation 4 and thus, Equations 5a, 5b, 5c, and 5d may be formulated.

q=(└ q̅+½┘+v·(−1)^{└2 q̅┘}+n_{cluster})mod N_{ZC}^{RS}

q̅=N_{ZC}^{RS}·(u+1)/31 [Equation 5a]

q=(└ q̅+½┘+v·(−1)^{└2 q̅┘}+N_{offset}^{cluster})mod N_{ZC}^{RS}

q̅=N_{ZC}^{RS}·(u+1)/31 [Equation 5b]

q=[(n_{cluster}+1)·(└ q̅+½┘+v·(−1)^{└2 q̅┘})] mod N_{ZC}^{RS}

q̅=N_{ZC}^{RS}·(u+1)/31 [Equation 5c]

q=[(N_{offset}^{cluser}+1)(└ q̅+½┘+v·(−1)^{└2 q̅┘})] mod N_{ZC}^{RS}

q̅=N_{ZC}^{RS}·(u+1)/31 [Equation 5d]

### Embodiment 2

### A Scheme of Changing a Sequence-Group Number u

The sequence-group number u may be expressed by a total of 30 values, by adding a group hopping pattern f_{gh}(nₛ) and a sequence-shift pattern fₛₛ, and performing modular 30.

u=(f_{gh}(nₛ)+fₛₛ)mod 30 [Equation 6]

Also, the group hopping pattern f_{gh}(nₛ) may be expressed by Equation 7, and an initial value of a PN sequence c(i) of Equation 7 may be expressed by Equation 8.

[Equation 7]

$$\begin{matrix}{f}_{gh} ( {n}_{s} ) = \{ \begin{matrix}0 & \begin{matrix}if group hopping \\ is disabled\end{matrix} \\ ( {\sum }_{i = 0}^{7} c ( 8 {n}_{s} + i ) \cdot {2}^{i} ) mod 30 & \begin{matrix}if group hopping \\ is enabled\end{matrix} \end{matrix} & \\ {c}_{init} = ⌊ \frac{{N}_{ID}^{cell}}{30} ⌋ & [ Equation 8 ]\end{matrix}$$

In a case of a PUCCH, the sequence-shift pattern fₛₛ may be expressed by Equation 9. In a case of a PUSCH, the sequence-shift pattern fₛₛ may be expressed by Equation 10.

$$\begin{matrix}{f}_{ss}^{PUCCH} = {N}_{ID}^{cell} mod 30 & [ Equation 9 ] \\ {f}_{ss}^{PUSCH} = ( {f}_{ss}^{PUCCH} + {Δ}_{ss} ) mod 30 \\ Here , {Δ}_{ss} ∈ \{ 0 , 1 , … , 29 \} & [ Equation 10 ]\end{matrix}$$

### Embodiment 2-1

A cluster number or an offset value for each cluster may be directly added to is the u. Accordingly, Equation 6 may be modulated to Equation 11a, Equation 11b, Equation 11c, and Equation 11d.

u=(f_{gh}(nₛ)+fₛₛ+n_{cluster})mod 30 [Equation 11a]

u=(f_{gh}(nₛ)+fₛₛ+N_{offset}^{cluster})mod 30 [Equation 11b]

u=[(n_{cluster}+1)·(f_{gh}(nₛ)+fₛₛ] mod 30 [Equation 11c]

u=[(N_{offset}^{cluster}+1)·(f_{gh}(nₛ)+fₛₛ)] mod 30 [Equation 11d]

### Embodiment 2-2

A cluster number or an offset value for each cluster may be added to Equation 7 that forms f_{gh}(nₛ). Accordingly, Equation 7 may be modulated to Equation 12a and Equation 12b.

$$\begin{matrix}{f}_{gh} ( {n}_{s} , {N}_{ID}^{CC} ) = \{ \begin{matrix}0 & \begin{matrix}if group hopping \\ is disabled\end{matrix} \\ ( {\sum }_{i = 0}^{7} c ( 160 {n}_{cluster} + 8 {n}_{s} + i ) \cdot {2}^{i} ) mod 30 & \begin{matrix}if group hopping \\ is enabled\end{matrix}\end{matrix} & [ Equation 12 a ] \\ {f}_{gh} ( {n}_{s} , {N}_{offset}^{CC} ) = \{ \begin{matrix}0 & \begin{matrix}if group hopping \\ is disabled\end{matrix} \\ ( {\sum }_{i = 0}^{7} c ( 160 {N}_{offset}^{cluster} + 8 {n}_{s} + i ) \cdot {2}^{i} ) mod 30 & \begin{matrix}if group hopping \\ is enabled\end{matrix}\end{matrix} & [ Equation 12 b ]\end{matrix}$$

The wireless communication system that uses a plurality of resource clusters according to embodiments of the present invention may generate a different f_{gh}(nₛ) value for each resource cluster by dividing 160 PN sequence c(i) values based on 8 bits for each resource cluster.

As described in the foregoing, when a number of existing clusters is 1, a different PN sequence c(i) may be formed for each cell, the PN sequence is divided based on 8 bits for each slot, and modular 30 may be performed on values from 1 to 255 corresponding to the decimal system and thus, a f_{gh}(nₛ) value for each slot may be determined.

Here, when a plurality of clusters is used, 160 different PN sequence c(i) values may be used based on 8 bits for each of 20 slots and for each cluster. For a subsequent cluster, another 160 PN sequence c(i) values may be used based 8 bits and thus, a different f_{gh}(nₛ) value may be randomly generated for each cluster as well as for each slot.

### Embodiment 2-3

A cluster number or an offset value for each cluster may be added to Equation 8 forming an initial value of f_{gh}(nₛ) and thus, Equation 13a and Equation 13b may be formulated.

$$\begin{matrix}{c}_{init} = {n}_{cluster} \cdot {2}^{5} + ⌊ \frac{{N}_{ID}^{cell}}{30} ⌋ & [ Equation 13 a ] \\ {c}_{init} = {N}_{offset}^{cluster} \cdot {2}^{5} + ⌊ \frac{{N}_{ID}^{cell}}{30} ⌋ & [ Equation 13 b ]\end{matrix}$$

### Embodiment 2-4

A cluster number or an offset value for each cluster may be added to Equation 9 forming a sequence-shift pattern value fₛₛ. Accordingly, Equation 9 may be modulated to Equation 14a and Equation 14b.

fₛₛ^{PUCCH}=(N_{ID}^{cell}+n_{cluster})mod 30 [Equation 14a]

fₛₛ^{PUCCH}=(N_{ID}^{cell}+N_{offset}^{cluster})mod 30 [Equation 14b]

### Embodiment 3

### A Scheme of Changing a Phase Cyclic Shift Value α for Each Resource Cluster

(1) DM-RS for PUSCH

A phase cyclic shift value of a DM-RS used for a PUSCH may be α=2πn_{cs}/12, and n_{cs} may be expressed by Equation 15.

n_{cs}=(n_{DMRS}⁽¹⁾+n_{DMRS}⁽²⁾+n_{PRS}(nₛ))mod 12 [Equation 15]

In Equation 15, n_{DMRS}⁽¹⁾ and n_{DMRS}⁽²⁾ may be defined by a cyclic shift value obtained from an upper stage and a cyclic shift value for a DCI format 0, respectively.

Here, n_{PRS}(nₛ) may be expressed by Equation 16.

n_{PRS}(nₛ)=Σᵢ₌₀⁷c(8N_{symb}^{UL}·nₛ+i)·2ⁱ [Equation 16]

In Equation 16, N_{symb}^{UL} denotes a number of symbols in a UL.

In this example, an initial value of a PN sequence c(i) of Equation 16 may be expressed by Equation 17.

$${c}_{init} = ⌊ \frac{{N}_{ID}^{cell}}{30} ⌋ \cdot {2}^{5} + {f}_{ss}^{PUSCH} \qquad [ Equation 17 ]$$

### Embodiment 3-1-A

A cluster number or an offset value for each cluster may be added to n_{cs} forming the phase cyclic shift value α. Accordingly, Equation 15 may be modulated to is Equation 18a, Equation 18b, Equation 18c, and Equation 18d.

α=2πn_{cs}/12; n_{cs}=(n_{DMRS}⁽¹⁾+n_{DMRS}⁽²⁾+n_{PRS}(nₛ)+n_{cluster})mod 12 [Equation 18a]

α=2πn_{cs}/12; n_{cs}=(n_{DMRS}⁽¹⁾+n_{DMRS}⁽²⁾+n_{PRS}(nₛ)+N_{offset}^{cluster})mod 12 [Equation 18b]

α=2π·(n_{cluster}+1)·n_{cs}/12; n_{cs}=(n_{DMRS}⁽¹⁾+n_{DMRS}⁽²⁾+n_{PRS}(nₛ))mod 12 [Equation 18c]

α=2π·(N_{offset}^{cluster}+1)·n_{cs}/12; n_{cs}=(n_{DMRS}⁽¹⁾+n_{DMRS}⁽²⁾+n_{PRS}(nₛ))mod 12 [Equation 18d]

### Embodiment 3-1-B

A cluster number or an offset value for each cluster may be added to Equation 16 forming n_{PRS}(nₛ) and thus, Equation 19a and Equation 19b may be formulated.

n_{PRS}(nₛ,N_{ID}^{CC})=Σᵢ₌₀⁷c(160N_{symb}^{UL}·n_{cluster}+8N_{symb}^{UL}·nₛ+i)·2ⁱ [Equation 19a]

n_{PRS}(nₛ,N_{offset}^{CC})=Σᵢ₌₀⁷c(160N_{symb}^{UL}·N_{offset}^{cluster}+8N_{symb}^{UL}·nₛ+i)·2ⁱ [Equation 19b]

### Embodiment 3-1-C

A cluster number or an offset value for each cluster may be added to Equation 17 forming an initial value c(i) of n_{PRS}(nₛ) and thus, Equation 20a and Equation 20b may be formulated.

$$\begin{matrix}{c}_{init} = {n}_{cluster} \cdot {2}^{10} + ⌊ \frac{{N}_{ID}^{cell}}{30} ⌋ \cdot {2}^{5} + {f}_{ss}^{PUSCH} & [ Equation 20 a ] \\ {c}_{init} = {N}_{offset}^{cluster} \cdot {2}^{10} + ⌊ \frac{{N}_{ID}^{cell}}{30} ⌋ \cdot {2}^{5} + {f}_{ss}^{PUSCH} & [ Equation 20 b ]\end{matrix}$$

(2) DM-RS for PUCCH

A phase cyclic shift value of a DM-RS for a PUCCH may be α(nₛ,l)=2π· n̅_{cs}(nₛ,l)/N_{sc}^{RB}, and n̅_{cs}(nₛ,l) may be expressed by Equation 21. Here, N_{sc}^{RB} denotes a number of subcarriers in an RB.

$${\overline{n}}_{cs} ( {n}_{s} , l ) = \{ \begin{matrix}[ {n}_{cs}^{cell} ( {n}_{s} , l ) + ( {n}^{′} ( {n}_{s} ) \cdot {Δ}_{shift}^{PUCCH} + ( {\overline{n}}_{oc} ( {n}_{s} ) mod {Δ}_{shift}^{PUCCH} ) ) mod {N}^{′} ] mod {N}_{sc}^{RB} \\ [ {n}_{cs}^{cell} ( {n}_{s} , l ) + ( {n}^{′} ( {n}_{s} ) \cdot {Δ}_{shift}^{PUCCH} + {\overline{n}}_{oc} ( {n}_{s} ) ) mod {N}^{′} ] mod {N}_{sc}^{RB}\end{matrix} \qquad [ Equation 21 ]$$

In Equation 21, an upper stage corresponds to a normal cyclic prefix and a lower stage corresponds to an extended cyclic prefix. In this example, n̅_{oc}(nₛ) denotes an orthogonal sequence index, Δ_{shift}^{PUCCH} denotes a PUCCH shift parameter obtained from an upper stage, and n′(nₛ) and N′ may be system parameters obtained from a system of the upper stage. In Equation 21, n_{cs}^{cell}(nₛ,l) may be expressed by Equation 22.

n_{cs}^{cell}(nₛ,l)=Σᵢ₌₀⁷c(8N_{symb}^{UL}·nₛ+8l+i)·2ⁱ [Equation 22]

In this example, an initial value of a PN sequence c(i) in Equation 22 may be expressed by Equation 23.

cᵢₙᵢₜ=N_{ID}^{cell} [Equation 23]

### Embodiment 3-2-A

A cluster number or an offset value for each cluster may be added to n̅_{cs}(nₛ,l). Accordingly, Equation 21 may be modulated to Equation 24a and Equation 24b.

$${\overline{n}}_{cs} ( {n}_{s} , l , {n}_{cluster} ) = \{ \begin{matrix}[ {n}_{cs}^{cell} ( {n}_{s} , l ) + ( {n}^{′} ( {n}_{s} ) \cdot {Δ}_{shift}^{PUCCH} + ( {\overline{n}}_{oc} ( {n}_{s} ) mod {Δ}_{shift}^{PUCCH} ) ) mod {N}^{′} + {n}_{cluster} ] mod {N}_{sc}^{RB} \\ [ {n}_{cs}^{cell} ( {n}_{s} , l ) + ( {n}^{′} ( {n}_{s} ) \cdot {Δ}_{shift}^{PUCCH} + {\overline{n}}_{oc} ( {n}_{s} ) ) mod {N}^{′} + {n}_{cluster} ] mod {N}_{sc}^{RB}\end{matrix} \qquad \begin{matrix}\begin{matrix}[ Equation 24 a ] \\ ( 1 )\end{matrix} \\ ( 2 )\end{matrix}$$

(1) for normal cyclic prefix (2) for extended cyclic prefix

$${\overline{n}}_{cs} ( {n}_{s} , l , {N}_{offset}^{cluster} ) = \{ \begin{matrix}[ {n}_{cs}^{cell} ( {n}_{s} , l ) + ( {n}^{′} ( {n}_{s} ) \cdot {Δ}_{shift}^{PUCCH} + ( {\overline{n}}_{oc} ( {n}_{s} ) mod {Δ}_{shift}^{PUCCH} ) ) mod {N}^{′} + {N}_{offset}^{cluster} ] mod {N}_{sc}^{RB} \\ [ {n}_{cs}^{cell} ( {n}_{s} , l ) + ( {n}^{′} ( {n}_{s} ) \cdot {Δ}_{shift}^{PUCCH} + {\overline{n}}_{oc} ( {n}_{s} ) ) mod {N}^{′} + {N}_{offset}^{cluster} ] mod {N}_{sc}^{RB}\end{matrix} \qquad \begin{matrix}\begin{matrix}[ Equation 24 b ] \\ ( 1 )\end{matrix} \\ ( 2 )\end{matrix}$$

(1) for normal cyclic prefix (2) for extended cyclic prefix

In each of Equation 24a and Equation 24b, an upper stage corresponds to a normal cyclic prefix and a lower stage corresponds to an extended cyclic prefix.

### Embodiment 3-2-B

A cluster number or an offset value for each cluster may be added to Equation 22 forming n_{cs}^{cell}(nₛ,l) and thus, Equation 25a and Equation 25b may be formulated.

n_{cs}^{cell}(nₛ,l,N_{ID}^{CC})=Σᵢ₌₀⁷c(160N_{symb}^{UL}·n_{cluster}+8N_{symb}^{UL}·nₛ+8l+i)·2ⁱ [Equation 25a]

n_{cs}^{cell}(nₛ,l,N_{offset}^{cluster})=Σᵢ₌₀⁷c(160N_{symb}^{UL}·N_{offset}^{cluster}+8N_{symb}^{UL}·nₛ+8l+i)·2ⁱ [Equation 25b]

### Embodiment 3-2-C

A cluster number or an offset value for each cluster may be added to Equation 23 forming an initial value of n_{cs}^{cell}(nₛ,l) and thus, Equation 26a and Equation 26b may be formulated.

cᵢₙᵢₜ=n_{cluster}·2⁹+N_{ID}^{cell} [Equation 26a]

cᵢₙᵢₜ=N_{offset}^{cluster}·2⁹+N_{ID}^{cell} [Equation 26b]

(3) SRS

A phase cyclic shift value of an SRS may be α=2π·n_{SRS}^{CS}/8, and n_{SRS}^{CS}=0, 1, 2, 3, 4, 5, 6, 7, which is determined in an upper stage for each UE.

### Embodiment 3-3

A cluster number or an offset value for each cluster may be directly added to n_{SRS}^{CS} forming α. When α is expressed by reflecting the above, Equation 27a, Equation 27b, Equation 27c, and Equation 27d may be formulated.

α=2π·{(n_{SRS}^{CS}+n_{cluster})mod 8}/8 [Equation 27a]

α=2π·{(n_{SRS}^{CS}+N_{offset}^{cluster})mod 8}/8 [Equation 27b]

α=2π·[(n_{cluster}+1)·n_{SRS}^{CS}]/8 [Equation 27c]

α=2π·[(N_{offset}^{cluster}+1)·n_{SRS}^{CS}]/8 [Equation 27d]

As described in the foregoing, a wireless communication system that uses at least two resource clusters may generate an RS through an operation that adds a cluster number is or an offset value for each resource cluster on a basis of a Zadoff-chu sequence so as to form different base-sequences for each cluster, and an operation that adds a resource cluster number or an offset value for each resource cluster and applies a predetermined phase cyclic shift value α that is different for each resource cluster to the base-sequence so as to generate an RS sequence r_{u,v}^{(α)}(n) that is distinguished for each resource cluster. In this example, the generated RS may be transmitted for each resource cluster.

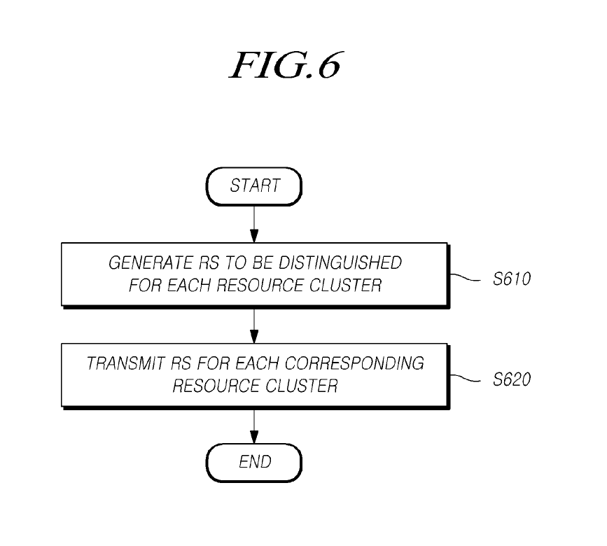

FIG. 6 illustrates a process of transmitting an RS according to an embodiment of the present invention.

Referring to FIG. 6, an RS sequence that is distinguished for each resource cluster in a wireless communication system that uses a plurality of resource clusters may generate a different RS for each cell and for each resource cluster (step S610). In this example, even in the same N^{th} slot, RS sequences different for each resource cluster may be formed.

For example, as illustrated in FIG. 5, an RS sequence of a first slot of cluster #0 in the first slot may be (fa(0), fa(1) . . . fa(N−1)), an RS sequence of a first slot of cluster #1 may be (fh(0), fh(1) . . . fh(N−1)), . . . , and an RS sequence of a first slot of cluster #m may be (fx(0), fx(1) . . . fx(N−1)).

Based on the different RS sequence for each resource cluster, RSs that are is distinguished for each resource cluster may be generated.

Subsequently, the RSs that are distinguished for each resource cluster may be transmitted for each resource cluster (step S620).

For example, when the RS is a DM-RS or an SRS for a PUCCH or a PUSCH, the RS may be regularly transmitted, for each resource cluster, to a portion of the 2D communication resource region of time/frequency domains based on a currently determined scheme or a scheme to be determined in the future.

Since the scheme of regularly transmitting an RS for each resource cluster to a portion of the 2D communication resource region of time/frequency domains is beyond the scope of the embodiments of the present invention, the scheme will not described in detail. However, the currently determined scheme or the scheme to be determined in the future may be included in the embodiments of the present invention. Although the embodiments of the present invention have been described with reference to accompanying drawings, the embodiments of the present invention may not be limited thereto.

As described in the foregoing, different base sequences r̅_{u,v}(n) may be formed by using a difference phase cyclic shift value α, a different root value q of the Zadoff-chu sequence, or a different sequence-group number u for each cluster and thus, RSs different for each resource cluster may be formed.

In this example, from among the methods of forming different RSs for each is cluster according to the embodiment of the present invention, merely one method may be used or a few methods may be used together.

Also, the embodiments of the present invention have described a UL RS as an example, and may be applicable to a DL RS in the same manner as the UL RS.

In the embodiments of the present invention, although a cluster number is expressed by, for example, a parameter n_{cluster} and the like, and an offset value for each cluster is expressed by, for example, a parameter N_{offset}^{cluster} and the like, the expression of each parameter may be changed within the scope of a meaning of each parameter.

In particular, when a number of clusters is M, the cluster number may have a total of M values, that is, n_{cluster}={0, 1, . . . , M−1}. When the number of clusters is M, the offset value for each cluster may have a total of M values, that is, N_{offset}^{cluster}={0, 1, . . . , M−1}. However, when the offset value for each cluster may have M or less values, added parameters may be simplified and thus, an overhead may be reduced although an effect of reducing a CM/PAPR is low.

For example, when two or three offset values for each cluster are used, the total of M clusters may be mapped to be two or three groups.

Also, an offset value of a first cluster or a cluster having a largest bandwidth from among the M clusters may be set to 0, and offset values of remaining clusters may be set to 1.

Accordingly, other signal sequences in addition to an RS may be generated and, signals different for each resource cluster may be formed/generated.

Also, although embodiments of the present invention have been described based on a case in which the base-sequence is Zadoff-chu sequence, other sequences in addition to the Zadoff-chu sequence may be applicable. For example, a constant amplitude zero auto-correlation sequence may be used as the base-sequence.

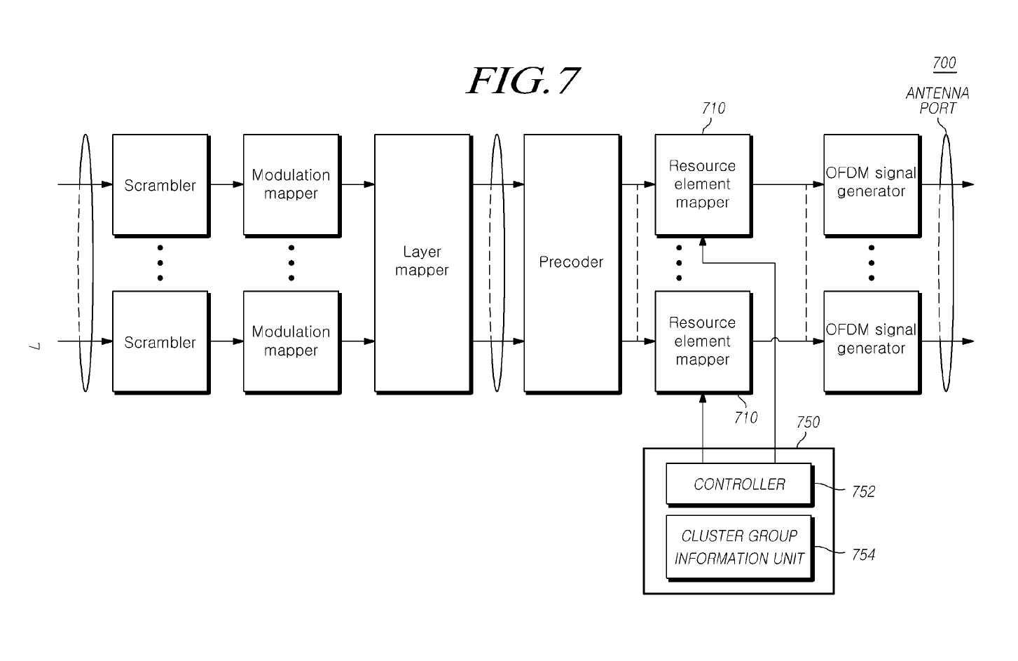

FIG. 7 illustrates a block that generates an RS according to an embodiment of the present invention

Referring to FIG. 7, a basic operation of a wireless communication system 700 is illustrated. Bits input as code words after channel coding in a DL may be scrambled by a scrambler, and may be input to a modulation mapper. The modulation mapper may modulate the scrambled bits into a complex modulation symbol, and a layer mapper may map the complex modulation symbol to a single or a plurality of transmission layers. Subsequently, a precoder may perform precoding of a complex modulation symbol in each transmission channel of an antenna port. Subsequently, a resource element mapper may perform mapping of the complex modulation symbol of each antenna port to a corresponding resource element.

An RS generator 750 may include a controller 752 and a cluster group is information unit 754.

The cluster group information unit 754 may determine information associated with an RBG corresponding to a bundle of RBs allocated to a CC of a predetermined cell, that is, information associated with an available resource cluster, and may transmit the information to the controller 752.

Based on the information provided by the cluster group information unit 754, the cluster controller 752 may change a phase cyclic shift value α for each available resource cluster, or may change a root value q of a Zadoff-chu sequence or a sequence-group number u, so as to control a base-sequence r̅_{u,v}(n) to be different (for each resource cluster).

The RS generator 750 may form an RS to be distinguished for each resource cluster. Schemes described with reference to FIG. 5 may be applied to when an RS to be distinguished for each resource cluster is generated.

When the RS generator 750 generates an RS having a different period for each cluster group, the RS generator 750 may assign a corresponding RS to a time-frequency domain that is different for each antenna port by working in conjunction with the resource element mapper.

In this example, control signals such as an RS generated for each cluster group may be assigned to a few of resource elements first, and then data input from the precoder may be assigned to remaining resource elements.

Subsequently, an OFDM signal generator generates a complex time-domain OFDM signal for each antenna port, and may transmit the complex time-domain OFDM signal to a corresponding antenna port. That is, the OFDM signal generator may transmit an RS that is distinguished for each cluster group that is generated based on an eNB transmission frame, at a predetermined frame timing.

In FIG. 7, the RS generator 750 and the resource element mapper 710 may be configured as separate hardware blocks or may be configured as a block that is logically distinguished by software.

However, a receiving apparatus may restore an RS based on a reverse operation of a transmitting apparatus. Accordingly, the receiving apparatus may correspond to an eNB apparatus, and may receive and distinguish a corresponding RS, that is, an RS of an assigned frequency domain from among RSs generated for each cluster, based on Equations described in FIG. 5.

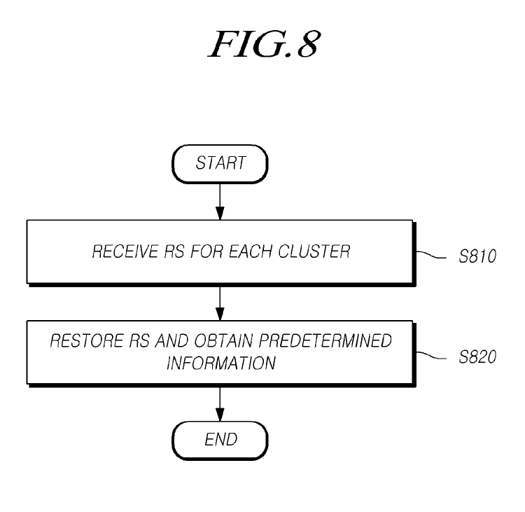

FIG. 8 illustrates a method of receiving an RS according to an embodiment of the present invention.

Referring to FIG. 8, the method may include an operation of receiving an RS for each cluster, which is generated and transmitted by an RS transmitting apparatus (step S810), and an operation of restoring the RS and obtaining predetermined information (step S820).

The predetermined information obtained by restoring the RS may be is demodulation information when the RS is a DM-RS, and may be channel estimation information, channel state information, and the like when the RS is an SRS, but may not be limited thereto.

An RS for each cluster may be generated based on an RS sequence that is distinguished for each of at least one cluster corresponding to successive resource blocks from among a plurality of subcarrier sets.

As described in FIG. 5 and the like, the RS for each cluster may be generated by forming a base-sequence based on a Zadoff-chu sequence, and performing phase cyclic shift for each cluster so as to form an RS sequence r_{u,v}^{(α)}(n). In this example, the RS for each cluster may be generated by performing at least one of generating a different Zadoff-chu sequence for each cluster so as to form different base-sequences, and generating the RS sequence by changing a phase cyclic shift value α for each cluster.

Also, when different base-sequences are formed by generating a different Zadoff-chu sequence for each cluster, different base-sequences r_{u,v}^{(α)}(n) may be generated by changing a root value q of the Zadoff-chu sequence or a sequence-group number u forming the root value q of the Zadoff-chu sequence.

Also, when the RS sequence is generated by changing a phase cyclic shift value α for each cluster, the RS sequence may be generated by applying at least one of

α=2πn_{cs}/12 and

n_{cs}=(n_{DMRS}⁽¹⁾+n_{DMRS}⁽²⁾+n_{PRS}(nₛ)+n_{cluster})mod 12, 1)

α=2πn_{cs}/12 and

n_{cs}=(n_{DMRS}⁽¹⁾+n_{DMRS}⁽²⁾+n_{PRS}(nₛ)+N_{offset}^{cluster})mod 12, 2)

α=2π·(n_{cluster}+1)·n_{cs}/12 and

n_{cs}=(n_{DMRS}⁽¹⁾+n_{DMRS}⁽²⁾+n_{PRS}(nₛ))mod 12, and 3)

α=2π·(N_{offset}^{cluster}+1)·n_{cs}/12 and

n_{cs}=(n_{DMRS}⁽¹⁾+n_{DMRS}⁽²⁾+n_{PRS}(nₛ))mod 12. 4)

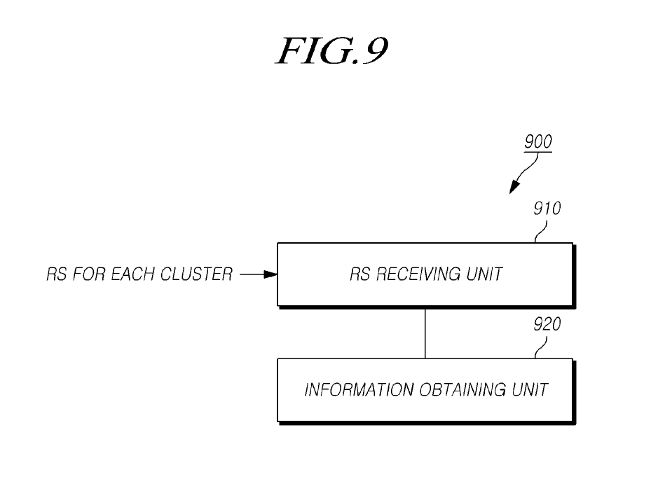

FIG. 9 illustrates a configuration of an RS receiving apparatus according to an embodiment of the present invention.

An RS receiving apparatus 900 may include an RS receiving unit 910 to receive an RS for each cluster, corresponding to clusters assigned to itself as resources, and an information obtaining unit 920 to restore the received RS so as to obtain predetermined information.

Here, the RS for each cluster may be generated and transmitted by an RS transmitting apparatus. The RS may be generated based on an RS sequence that is distinguished for each of at least one cluster corresponding to a successive resource blocks from among a plurality of subcarrier sets.

When the RS is a UL RS such as a DM-RS or an SRS, the RS receiving apparatus according to embodiments of the present invention may be embodied in an apparatus is such as a base station, an eNB, and the like or may be embodied by working in conjunction with the apparatus.

Predetermined information obtained by the information obtaining unit 920 may be demodulation information when the RS is a DM-RS, and may be channel estimation information, channel state information, and the like when the RS is an SRS, but may not be limited thereto.

As described in the foregoing, the RS for each cluster that the RS receiving apparatus receives may be generated by forming a base-sequence based on a Zadoff-chu sequence, and performing phase cyclic shift for each cluster so as to form an RS sequence. In this example, the RS for each cluster may be generated by performing at least one of generating a different Zadoff-chu sequence for each cluster so as to form different base-sequences, and generating the RS sequence by changing a phase cyclic shift value α for each cluster.

Also, when different base-sequences are formed by generating a different Zadoff-chu sequence for each cluster, different base-sequences may be generated by changing a to root value q of the Zadoff-chu sequence or a sequence-group number u forming the root value q of the Zadoff-chu sequence.

Although exemplary embodiments of the present invention have been described for illustrative purposes, those skilled in the art will appreciate that various modifications, additions and substitutions are possible, without departing from the scope and is spirit of the invention as disclosed in the accompanying claims. Therefore, the embodiments disclosed in the present invention are intended to illustrate the scope of the technical idea of the present invention, and the scope of the present invention is not limited by the embodiment. The scope of the present invention shall be construed on the basis of the accompanying claims in such a manner that all of the technical ideas included within the scope equivalent to the claims belong to the present invention.

1. A method for transmitting a reference signal in a wireless communication system, the method comprising:
identifying at least one cluster corresponding to successive resource blocks from among a plurality of subcarrier sets;
generating a reference signal sequence to be distinguished for each identified cluster; and
generating a reference signal to be distinguished for each identified cluster, based on the generated reference signal sequence.

2. The method as claimed in claim 1, wherein generating of the reference signal comprises:
forming a base-sequence based on a Zadoff-chu sequence, and performing phase cyclic shift for each identified cluster to form a reference signal sequence r_{u,v}^{(α)}(n); and
performing at least one of generating a different Zadoff-chu sequence for each identified cluster to generate different base sequences, and generating a reference signal sequence by using a different phase cyclic shift value α for each identified cluster.

3. The method as claimed in claim 2, wherein generating of the different Zadoff-chu sequence for each identified cluster to generate the different base
generating the different base sequences r_{u,v}^{(α)}(n) by changing a root value q of the Zadoff-chu sequence or by changing a sequence-group number u forming the root value q of the Zadoff-chu sequence.

4. The method as claimed in claim 2, wherein generating of the reference signal sequence using the different phase cyclic shift value α for each identified cluster comprises:
generating the reference signal sequence by applying at least one of:
α=2πn_{cs}/12, and
n_{cs}=(n_{DMRS}⁽¹⁾+n_{DMRS}⁽²⁾+n_{PRS}(nₛ)+n_{cluster})mod 12; 1)
α=2πn_{cs}/12, and
n_{cs}=(n_{DMRS}⁽¹⁾+n_{DMRS}⁽²⁾+n_{PRS}(nₛ)+N_{offset}^{cluster})mod 12; 2)
α=2π·(n_{cluster}+1)·n_{cs}/12, and
n_{cs}=(n_{DMRS}⁽¹⁾+n_{DMRS}⁽²⁾+n_{PRS}(nₛ))mod 12; and 3)
α=2π·(N_{offset}^{cluster}+1)·n_{cs}/12, and
n_{cs}=(n_{DMRS}⁽¹⁾+n_{DMRS}⁽²⁾+n_{PRS}(nₛ))mod 12. 4)

5. An apparatus to transmitting a reference signal in a wireless communication system, the apparatus comprising:
a cluster group information unit to identify clusters corresponding to successive resource blocks from among a plurality of subcarrier sets;
a controller to perform controlling to generate a reference signal sequence to be distinguished for each identified cluster; and
a reference signal generator to generate a reference signal to be distinguished for each identified cluster, based on the generated reference signal sequence.

6. The apparatus as claimed in claim 5, wherein the reference signal generator performs:
forming a base-sequence based on a Zadoff-chu sequence, and performing phase cyclic shift for each identified cluster to form a reference signal sequence r_{u,v}^{(α)}(n); and
performing at least one of generating a different Zadoff-chu sequence for each identified cluster to generate different base sequences, and generating a reference signal sequence by using a different phase cyclic shift value α for each identified cluster.

7. The apparatus as claimed in claim 6, wherein the reference signal generator performs:
generating a different Zadoff-chu sequence for each identified cluster to generate different base sequences; and
generating the different base sequences r_{u,v}^{(α)}(n) by changing a root value q of the Zadoff-chu sequence or by changing a sequence-group number u forming the root value q of the Zadoff-chu sequence.

8. The apparatus as claimed in claim 6, wherein, when the reference signal generator generates the reference signal sequence by using the different phase cyclic shift value α for each identified cluster, the reference signal sequence is generated by applying at least one of:
α=2πn_{cs}/12, and
n_{cs}=(n_{DMRS}⁽¹⁾+n_{DMRS}⁽²⁾+n_{PRS}(nₛ)+n_{cluster})mod 12; 1)
α=2πn_{cs}/12, and
n_{cs}=(n_{DMRS}⁽¹⁾+n_{DMRS}⁽²⁾+n_{PRS}(nₛ)+N_{offset}^{cluster})mod 12; 2)
α=2π·(n_{cluster}+1)·n_{cs}/12, and
n_{cs}=(n_{DMRS}⁽¹⁾+n_{DMRS}⁽²⁾+n_{PRS}(nₛ))mod 12; and 3)
α=2π·(N_{offset}^{cluster}+1)·n_{cs}/12, and
n_{cs}=(n_{DMRS}⁽¹⁾+n_{DMRS}⁽²⁾+n_{PRS}(nₛ))mod 12. 4)

9. A method for receiving a reference signal in a wireless communication system, the method comprising:
receiving a reference signal for each cluster, which is generated through use of a reference signal sequence distinguished for each of at least one cluster corresponding to successive resource blocks from among a plurality of subcarrier sets; and
restoring the reference signal to obtain predetermined information.

10. The method as claimed in claim 9, wherein the reference signal for each cluster is generated by forming a base-sequence based on a Zadoff-chu sequence, and performing phase cyclic shift for each identified cluster to form a reference signal sequence r_{u,v}^{(α)}(n), and performing at least one of generating a different Zadoff-chu sequence for each identified cluster to generate different base sequences, and generating a reference signal sequence by using a different phase cyclic shift value α for each identified cluster.

11. The method as claimed in claim 10, wherein, when the different Zadoff-chu sequence is generated for each identified cluster to generate the different base sequences, the different base sequences r_{u,v}^{(α)}(n) are generated by changing a root value q of the Zadoff-chu sequence or by changing a sequence-group number u forming the root value q of the Zadoff-chu sequence.

12. The method as claimed in claim 10, wherein, when the reference signal sequence is generated by using the different phase cyclic shift value α for each identified cluster, the reference signal sequence is generated by applying at least one of:
α=2πn_{cs}/12, and
n_{cs}=(n_{DMRS}⁽¹⁾+n_{DMRS}⁽²⁾+n_{PRS}(nₛ)+n_{cluster})mod 12; 1)
α=2πn_{cs}/12, and
n_{cs}=(n_{DMRS}⁽¹⁾+n_{DMRS}⁽²⁾+n_{PRS}(nₛ)+N_{offset}^{cluster})mod 12; 2)
α=2π·(n_{cluster}+1)·n_{cs}/12, and
n_{cs}=(n_{DMRS}⁽¹⁾+n_{DMRS}⁽²⁾+n_{PRS}(nₛ))mod 12; and 3)
α=2π·(N_{offset}^{cluster}+1)·n_{cs}/12, and
n_{cs}=(n_{DMRS}⁽¹⁾+n_{DMRS}⁽²⁾+n_{PRS}(nₛ))mod 12. 4)

13. An apparatus to receiving a reference signal in a wireless communication system, the apparatus comprising:
a reference signal receiving unit to receive a reference signal for each cluster, which is generated through use of a reference signal sequence distinguished for each of at least one cluster corresponding to successive resource blocks from among a plurality of subcarrier sets; and
an information obtaining unit to restore the received reference signal to obtain predetermined information.

14. The apparatus as claimed in claim 13, wherein the reference signal for each cluster is generated by forming a base-sequence based on a Zadoff-chu sequence, and performing phase cyclic shift for each identified cluster to form a reference signal sequence r_{u,v}^{(α)}(n), and performing at least one of generating a different Zadoff-chu sequence for each identified cluster to generate different base sequences, and generating a reference signal sequence by using a different phase cyclic shift value α for each identified cluster.

15. The apparatus as claimed in claim 14, wherein, when the different Zadoff-chu sequence is generated for each cluster to generate the different base sequences, the different base sequences r_{u,v}^{(α)}(n) are generated by changing a root value q of the Zadoff-chu sequence or by changing a sequence-group number u forming the root value q of the Zadoff-chu sequence.

16. The apparatus as claimed in claim 14, wherein, when the reference signal sequence is generated by using the different phase cyclic shift value α for each identified cluster, the reference signal sequence is generated by applying at least one of:
α=2πn_{cs}/12, and
n_{cs}=(n_{DMRS}⁽¹⁾+n_{DMRS}⁽²⁾+n_{PRS}(nₛ)+n_{cluster})mod 12; 1)
α=2πn_{cs}/12, and
n_{cs}=(n_{DMRS}⁽¹⁾+n_{DMRS}⁽²⁾+n_{PRS}(nₛ)+N_{offset}^{cluster})mod 12; 2)
α=2π·(n_{cluster}+1)·n_{cs}/12, and
n_{cs}=(n_{DMRS}⁽¹⁾+n_{DMRS}⁽²⁾+n_{PRS}(nₛ))mod 12; and 3)
α=2π·(N_{offset}^{cluster}+1)·n_{cs}/12, and
n_{cs}=(n_{DMRS}⁽¹⁾+n_{DMRS}⁽²⁾+n_{PRS}(nₛ))mod 12. 4)
